(19) United States
(12) Patent Application Publication
(10) Pub. No.: US 2026/0229529 A1
(43) Pub. Date: Aug. 6, 2026

(54) Dry Process Method of Manufacturing Electrode for Lithium Secondary Battery, Dry Electrode Produced by the Method, and Lithium Secondary Battery Including Same

(71) Applicants: HYUNDAI MOTOR COMPANY, SEOUL (KR); KIA CORPORATION, SEOUL (KR)

(72) Inventors: Hyun Jin Kim, Gyeonggi-do (KR); Min Ju Kim, Gyeonggi-do (KR); Young Soo Lee, Gyeonggi-do (KR); Han Nah Song, Gyeonggi-do (KR); Jong Hun Kang, Seoul (KR); Jang Wook Choi, Seoul (KR); Ji Hyeon Lim, Seoul (KR); Woo Jun Chung, Seoul (KR)

(73) Assignees: HYUNDAI MOTOR COMPANY, SEOUL (KR); KIA CORPORATION, SEOUL (KR); Seoul National University R&DB Foundation, Seoul (KR)

(21) Appl. No.: 19/316,516

(22) Filed: Sep. 2, 2025

(30) Foreign Application Priority Data
Jan. 31, 2025 (KR) 10-2025-0012413

(51) Int. Cl. H01M 4/62; H01M 4/04; H01M 10/052

(52) U.S. Cl. CPC H01M 4/625; H01M 4/043; H01M 10/052

(57) ABSTRACT

A method of manufacturing an electrode for a lithium secondary battery by a dry process using a conductive material including reduced graphene oxide and carbon nanotubes, a dry electrode for a lithium secondary battery manufactured thereby, and a lithium secondary battery including the same, in which mechanical properties, electrochemical performance, and durability of the electrode for a lithium secondary battery can be improved.

### CROSS-REFERENCE TO RELATED APPLICATION

This application claims, under 35 U.S.C. § 119 (a), the benefit of priority from Korean Patent Application No. 10-2025-0012413, filed on Jan. 31, 2025, the entire contents of which are incorporated herein by reference.

### FIELD

The present disclosure relates to a method of manufacturing an electrode for a lithium secondary battery by a dry process, a dry electrode for a lithium secondary battery manufactured thereby, and a lithium secondary battery including the same, in which mechanical properties, electrochemical performance, and durability of the electrode for a lithium secondary battery may be improved using a conductive material including reduced graphene oxide and carbon nanotubes.

### BACKGROUND

A battery is a device configured to store power using materials capable of electrochemical reaction at a cathode and an anode. A representative example of such a battery is a lithium secondary battery configured to store electrical energy created by a difference in chemical potential when lithium ions are intercalated/deintercalated at the cathode and anode. Lithium secondary batteries are used not only in small electronic devices such as mobile phones, laptops, etc., but also in large transportation vehicles such as, for example, hybrid cars and electric cars.

A lithium secondary battery is generally configured to include an anode current collector, an anode, an electrolyte, a separator, a cathode, and a cathode current collector. Typically, existing electrodes for lithium secondary batteries are manufactured by a wet process. When manufacturing electrodes using a wet process, a high-temperature drying process is required to remove a dispersion medium (e.g., solvent), however this high-temperature process can damage the electrode active material. Accordingly, a method of manufacturing an electrode that utilizes a dry process would avoid any damage to the electrode active material that is associated high-temperature drying process steps.

An electrode generally includes an electrode active material, a binder, and a conductive material for improving electronic conductivity of the electrode. When the conductive material incorporates a point-contact-based zero-dimensional carbon material such as carbon black, the carbon material particles can agglomerate, making it difficult to disperse the particles throughout the electrode. Challenges also exist when using a three-dimensional carbon material as the conductive material, as the small specific surface area of such materials make it very difficult to obtain sufficient electrical conductivity.

This results in the manufacture of an electrode with low contact density between electrode element materials and thus non-uniform electrical conductivity.

### SUMMARY

The present disclosure addresses the problems encountered in the art, and in one aspect, it provides a method of manufacturing an electrode for a lithium secondary battery by a dry process which avoids any need to remove a dispersion medium and any damage to an electrode active material associated with high temperature process steps (e.g., dispersion medium removal and/or drying).

In another aspect, the present disclosure provides a method of manufacturing an electrode for a lithium secondary battery, comprising providing a mixture of a one-dimensional carbon material and a two-dimensional carbon material as the conductive material included in the electrode, and wherein the method can provide an electrode having a sufficient specific surface area, and good dispersion, of a conductive material in the electrode.

An aspect of the present disclosure provides a method of manufacturing a dry electrode for a lithium secondary battery, including preparing a conductive material including reduced graphene oxide (rGO) and carbon nanotubes, obtaining an electrode composition by mixing the conductive material with an electrode active material and a binder, and manufacturing a dry electrode by applying pressure to the electrode composition.

In one embodiment, preparing the conductive material may include placing (e.g., contacting, mixing, etc.) an acid solution, graphite, and an oxidizing agent in a reactor followed by reaction, synthesizing graphene oxide by placing (e.g., contacting, mixing, etc.) water in the reactor followed by additional reaction, and synthesizing reduced graphene oxide by pyrolyzing the graphene oxide under a reducing atmosphere.

In embodiments, the additional reaction may be performed under any one of conditions including, for example, 0° C. to 10° C. for less than 1 minute, 65 to 75° C. for 90 to 150 minutes, and 98 to 100° C. for 10 to 20 minutes.

In one embodiment, the weight ratio of the reduced graphene oxide to the carbon nanotubes may be 0.5:1.5 to 1.5:0.5.

In one embodiment, the dry electrode may include 0.1 wt % to 5 wt % of the reduced graphene oxide, 0.1 wt % to 5 wt % of the carbon nanotubes, and 0.1 wt % to 5 wt % of the binder.

In one embodiment, the oxygen content in the reduced graphene oxide may be 0.2 wt % or less.

In one embodiment, the carbon nanotubes may include an average length of 0.1 μm to 200 μm, an average diameter of 1 nm to 20 nm, and an oxygen content of 0 wt % to 10 wt %.

In one embodiment, the method may include attaching the dry electrode to an electrode current collector.

Another aspect of the present disclosure provides a dry electrode for a lithium secondary battery including a conductive material including reduced graphene oxide (rGO) and carbon nanotubes, an electrode active material, and a binder, in which the conductive material, the electrode active material, and the binder are mixed in a dry manner/process.

In addition, the present disclosure provides a secondary battery including the dry electrode described above.

The disclosure provides other aspects, embodiments, and objects which will be apparent and clearly understood from the following description, figures, and the claims in various combinations and modifications.

### BRIEF DESCRIPTION OF THE DRAWINGS

Some aspects, embodiments, and features of the present disclosure are described in various detail with reference to certain exemplary embodiments that are illustrated in the accompanying drawings. The drawings provided herein are for purposes of illustration only and are not limiting to the aspects, embodiments, and features of present disclosure or to the claims.

FIG. 1 is a flowchart schematically showing a process of manufacturing an electrode for a lithium secondary battery in a dry manner/process according to an example embodiment of the present disclosure;

FIG. 2 shows results of analyzing the contact angle of reduced graphene oxide prepared under different additional reaction conditions in accordance with example embodiments of the disclosure (e.g., rGO_1, rGO_2, and rGO_3);

FIG. 3 shows results of Raman spectroscopy of defects of reduced graphene oxide prepared under different additional reaction conditions in accordance with example embodiments of the disclosure (e.g., rGO_1, rGO_2, and rGO_3);

FIG. 4 is a graph showing lifespan characteristics of lithium half-cells that include dry electrodes according to Example 1 and Comparative Examples 1 to 3;

FIG. 5 is a graph showing rate characteristics of the lithium half-cells that include dry electrodes according to Example 1 and Comparative Examples 1 to 3;

FIG. 6 shows stress-strain curves of the dry electrodes according to Example 1 and Comparative Examples 1 to 3;

FIG. 7 is a graph showing lifespan characteristics of lithium half-cells that include dry electrodes according to Examples 1 to 4 and Comparative Example 2;

FIG. 8 is a graph showing rate characteristics of the lithium half-cells that include the dry electrodes according to Examples 1 to 4 and Comparative Example 2;

FIG. 9 shows stress-strain curves of the dry electrodes according to Examples 1 to 3 and Comparative Example 2;

FIG. 10 is a graph showing lifespan characteristics of lithium half-cells that include dry electrodes according to Examples 1, 5, and 6 and Comparative Example 2;

FIG. 11 is a graph showing rate characteristics of the lithium half-cells that include the dry electrodes according to Examples 1, 5, and 6 and Comparative Example 2;

FIG. 12 shows stress-strain curves of the dry electrodes according to Examples 1, 5, and 6 and Comparative Examples 1 and 2;

FIG. 13 shows results of energy dispersive X-ray spectroscopy of the cross-section of the dry electrode according to Example 5 and the elements contained therein; and

FIGS. 14(a), 14(b), and 14(c) show results of scanning electron microscopy-energy dispersive X-ray spectroscopy (SEM-EDS) of the cross-section of the dry electrode according to Example 5.

### DETAILED DESCRIPTION

The above and other objects, features and advantages of the present disclosure will be more clearly understood from the following aspects and embodiments taken in conjunction with the accompanying drawings. However, neither the present disclosure nor the claims are limited to the embodiments disclosed herein, and may be modified into different forms in accordance with the guidance provided herein. The example aspects and embodiments are provided herein in an effort to thoroughly explain the various features of the disclosure and to convey the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise” or “comprising”, “include” or “including”, “have” or “having”, etc., when used in this specification, specify the presence of stated features, integers, steps, operations, elements, components, or combinations thereof, but do not preclude the presence or addition of one or more other features, integers, steps, operations, elements, components, or combinations thereof. In some aspects and embodiments, these terms should be understood to encompass the terms “consisting of” and “consisting essentially of” which refer to features, integers, numbers, steps, operations, elements, components, parts, or combinations thereof that only include the recited components, or the recited components allowing for minor amounts of other components or elements that do not have a material effect on the function of the recited feature, component, embodiment, or aspect of the disclosure. Thus, some aspects and embodiments may refer to these various transitionary terms, all of which form part of the disclosure.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Furthermore, unless specifically stated otherwise, the term “about” as used or implied herein may be understood within a range of error that is typical in the art (e.g., within 2 standard deviations of the mean). “About” may be understood as within 10%, 9%, 8%, 7%, 6%, 5%, 4%, 3%, 2%, 1%, 0.5%, 0.1%, 0.05%, or 0.01% of the stated value.

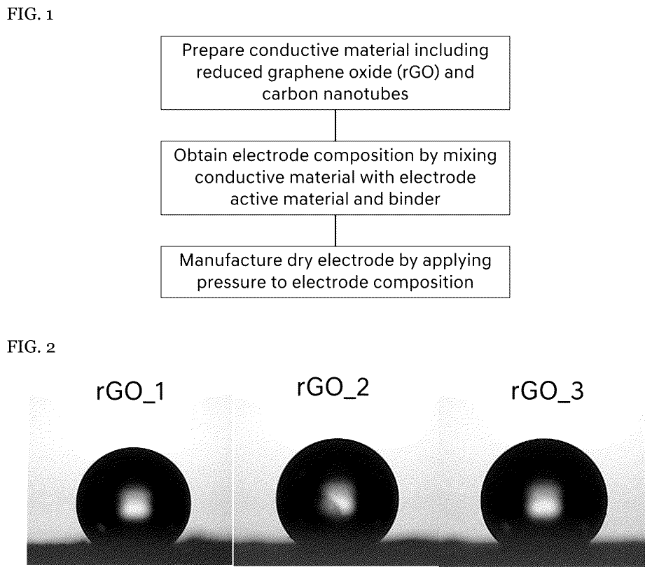

FIG. 1 is a flowchart schematically showing a process of manufacturing an electrode for a lithium secondary battery in a dry manner according to one embodiment of the present disclosure.

Referring to the embodiment depicted in FIG. 1, the method of manufacturing an electrode for a lithium secondary battery by a dry process may include preparing a conductive material including reduced graphene oxide (rGO) and carbon nanotubes, obtaining an electrode composition by mixing the conductive material with an electrode active material and a binder, and manufacturing a dry electrode by applying pressure to the electrode composition.

Various embodiments of certain steps that can be incorporated into methods accordance with the disclosure are described in more detail below.

### Preparing Conductive Material

In some embodiments of the disclosure, the method comprises a conductive material that includes carbon nanotubes (i.e., a one-dimensional carbon material), and reduced graphene oxide (rGO) (i.e., a two-dimensional carbon material).

Carbon nanotubes have excellent mechanical strength and, due to their linear structure, may provide improved electrical conductivity when compared to zero-dimensional carbon conductive materials. Thus, carbon nanotubes hold potential as a next-generation conductive material for lithium secondary batteries. However, carbon nanotubes can form bundles from agglomeration arising from strong van der Waals bonds resulting from π-π interactions in carbon materials that have spe bonds. Thus, when carbon nanotubes are used as the sole conductive material in a dry process for manufacturing an electrode, it may not disperse adequately in the electrode and movement of lithium ions may be hindered.

The disclosure overcomes the agglomeration issue by providing a dry process method comprising a mixture of carbon nanotubes and reduced graphene oxide as the conductive material, which allows the conductive material to more readily disperse in the electrode and provide for a sufficient specific surface area.

In some embodiments, the carbon nanotubes in accordance with the disclosure may be classified into single-walled carbon nanotubes, double-walled carbon nanotubes, multi-walled carbon nanotubes, rope-type carbon nanotubes, and the like, depending on the number of walls. In some particular embodiments, single-walled carbon nanotubes (SWCNTs) are used in the method.

In embodiments, the size and composition of the carbon nanotubes can vary within limits that are known in the art. In some non-limiting embodiments, carbon nanotubes can comprise an average length of 0.1 μm to 200 μm, an average diameter of 1 nm to 20 nm, and an oxygen content of 0 wt % to 10 wt %, for example.

In embodiments, the reduced graphene oxide in accordance with the disclosure may be provided or obtained from a commercial source or prepared using known methods. In one embodiment, the reduced graphene oxide (rGO) may be prepared by performing chemical exfoliation on graphite to form graphene oxide (GO) followed by thermal reduction.

In some further embodiments, preparing the reduced graphene oxide (rGO) may include placing (e.g., mixing, reacting, contacting, etc.) an acid solution, graphite, and an oxidizing agent in a reactor under conditions that allow for a first reaction product; synthesizing graphene oxide by placing (e.g., mixing, reacting, contacting, etc.) water with the first reaction product in the reactor under conditions that allow for a reaction to form graphene oxide, and synthesizing reduced graphene oxide by pyrolyzing the graphene oxide under a reducing atmosphere.

In some specific embodiments, an acid solution, such as a strong acid (for example, concentrated sulfuric acid), is placed in the reactor, and graphite and an oxidizing agent are added to the acid solution. In some embodiments, the oxidizing agent can comprise sodium nitrate (NaNO₃), potassium permanganate (KMnO₄), or other known oxidizing agents. In some further embodiments the oxidizing agent comprises potassium permanganate (KMnO₄).

Without being limited by mechanism, and merely to illustrate an example embodiment in accordance with the disclosure, the addition of oxidizing agent (e.g., potassium permanganate) to acid solution (e.g., sulfuric acid) in the reactor, reacts to form a reactive oxide (e.g., manganese heptoxide (Mn₂O₇)), which can oxidize graphite, causing chemical exfoliation.

In embodiments, conditions under which the oxidation reaction of graphite can occur are not particularly limited and, for example, can comprise reaction conditions that range in temperature and duration from about 35° C. to 45° C. and from about 2 to 24 hours.

Following the oxidation and formation of the first reaction product, water may be added (i.e., placed, mixed, reacted, contacted) with the first reaction product in the reactor.

Without being limited by mechanism, and merely to illustrate an example embodiment in accordance with the disclosure, upon addition of water in the reactor, concentrated strong acid (e.g., sulfuric acid) is converted into a strongly acidic aqueous solution, and the main oxidizing agent that induces oxidation reaction of graphite is converted from a reactive oxide (e.g., manganese heptoxide) into the agent that oxidizes graphite (e.g., permanganate ions). In an illustrative embodiment, the oxidation reaction of graphite by the permanganate ions affects the surface properties of graphene oxide, and also affects the degree of defect generation and oxygen content in the crystal structure of reduced graphene oxide prepared from graphene oxide. Accordingly, this illustrative embodiment demonstrates that the hydrophilicity and electrical conductivity of reduced graphene oxide may be improved by controlling the conditions for this additional reaction.

In one embodiment, the additional reaction may be performed under any one of a variety of temperatures and durations. In some embodiments, the conditions can comprise a temperature of 0° C. to 10° C. for less than 1 minute, a temperature of 65° C. to 75° C. for 90 to 150 minutes, and/or a temperature of 98° C. to 100° C. for 10 to 20 minutes. According to these various embodiments, (e.g., when additional oxidation reaction of graphite is performed at 0 to 10° C. for less than 1 minute, at 65 to 75° C. for 90 to 150 minutes, or at 98 to 100° C. for 10 to 20 minutes, or various combinations and/or variations thereof) the surface properties of graphene oxide may be controlled, and the hydrophilicity and electrical conductivity of reduced graphene oxide synthesized from graphene oxide may be improved.

In accordance with embodiments of the disclosure, after synthesis of the graphene oxide as described above or otherwise herein, the graphene oxide may be placed in a furnace and pyrolyzed under a reducing atmosphere, under conditions to synthesize reduced graphene oxide (rGO). In embodiments, the pyrolysis temperature and time are not particularly limited and can vary widely. For example, in some non-limiting embodiments, pyrolysis may be performed at 1,100° C. for 1 hour. In some embodiments, a reducing atmosphere may be achieved by introducing a reducing gas atmosphere such as, for example, a mixture of nitrogen and hydrogen in an appropriate ratio (e.g., about 9:1), into the furnace.

In one embodiment, the oxygen content in reduced graphene oxide obtained after pyrolysis may be 0.2 wt % or less. In some embodiments, the contact angle with water may be 150° or less. In some embodiments, based on characteristic results of Raman spectroscopy of the reduced graphene oxide, the ratio (I_{D}/I_{G}) of the peak intensity of the D band (I_{D}) to the peak intensity of the G band (I_{G}) may be 1.65 to 1.80.

When characterizing the rGO by Raman spectroscopy, the G band is typically assigned to a peak appearing at about 1580 cm⁻¹, and is observed in a carbon material having a hexagonal lattice of sp² bonded carbon as the basic structural unit, such as graphite, carbon nanotubes, and the like. The D band is typically assigned to a peak appearing at about 1350 cm⁻¹, and is associated with defects in the crystal structure, indicating the presence of amorphous carbon having poor crystallinity.

In one embodiment, the weight ratio of the reduced graphene oxide to the carbon nanotubes included in the conductive material may be 0.5:1.5 to 1.5:0.5, respectively. Without any limitation to underlying mechanisms, when the weight ratio of the carbon nanotubes exceeds 1.5 based on the 0.5 weight ratio of the reduced graphene oxide, discharge capacity and rate characteristics of the dry electrode including such a conductive material may decrease. Further, when the weight ratio of the carbon nanotubes is less than 0.5 based on the 1.5 weight ratio of the reduced graphene oxide, discharge capacity, capacity retention, rate characteristics, mechanical properties, etc. of the dry electrode including such a conductive material may decrease.

### Obtaining Electrode Composition

In accordance with various aspects and embodiments of the disclosure, an electrode composition may be prepared by mixing the conductive material obtained by the methods described herein with an electrode active material and a binder. The process of mixing the conductive material, the electrode active material, and the binder is not limited to any particular methods or embodiments, and typically comprises a dry mixing process (i.e., without incorporating a separate mixing solvent). For example, in non-limiting embodiments, mixing may be performed using a mixer such as a mini mill, a planetary mixer, a ball mill, a Homo mixer, and the like.

In some embodiments wherein the mixing process comprises a binder capable of being formed into microfibrils, such as PTFE, the electrode composition may be a fiberized electrode composition.

In one embodiment, the electrode active material includes a cathode active material or an anode active material, depending on whether the electrode to be manufactured using the electrode composition is a cathode or an anode.

In some embodiments, the cathode active material may be an oxide active material or a sulfide active material.

Non-limiting examples of the oxide active material include a rock salt-layer-type active material such as LiCoO₂, LiMnO₂, LiNiO₂, LiVO₂, Li₁₊ₓNi_{1/3}Co_{1/3}Mn_{1/3}O₂, LiNi_{1-(x+y)}CoₓMn_{y}O₂, and the like, a spinel-type active material such as LiMn₂O₄, Li(Ni_{0.5}Mn_{1.5})O₄, and the like, an inverse-spinel-type active material such as LiNiVO₄, LiCoVO₄, and the like, an olivine-type active material such as LiFePO₄, LiMnPO₄, LiCoPO₄, LiNiPO₄, and the like, a silicon-including active material such as Li₂FeSiO₄, Li₂MnSiO₄, and the like, a rock salt-layer-type active material in which a portion of a transition metal is substituted with a different metal, such as, for example, LiNi_{0.8}CO_{(0.2-x)}AlₓO₂ (0<x<0.2), a spinel-type active material in which a portion of a transition metal is substituted with a different metal, such as, for example, Li₁₊ₓMn_{2-x-y}M_{y}O₄ (in which M is at least one of Al, Mg, Co, Fe, Ni, and Zn, o<x+y<2), lithium titanate such as, for example, Li₄Ti₅O₁₂, and the like.

In some embodiments, the sulfide active material may be copper Chevrel (e.g., copper-containing molybdenum chalcogenides), iron sulfide, cobalt sulfide, nickel sulfide, and the like.

In some embodiments, the anode active material may include a carbon-based anode active material, a non-carbon-based anode active material, and the like.

In some further embodiments, the carbon-based anode active material may include graphite such as, for example, mesocarbon microbeads (MCMB), highly oriented pyrolytic graphite (HOPG), and the like; and amorphous carbon such as, for example, hard carbon and soft carbon. In some further embodiments, the non-carbon-based anode active material may include a metal, metal oxide, and the like, containing at least one of In, Al, Si, Sn, and combinations thereof.

Non-limiting examples of binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. In some preferred embodiments, the binder comprises PTFE.

### Manufacturing Dry Electrode

In embodiments, a dry electrode may be manufactured by applying pressure to the electrode composition obtained above.

The method of applying pressure to the electrode composition is not particularly limited. For example, a free-standing dry electrode may be manufactured by heating the electrode composition to a certain temperature and then applying shear force using a device such as a roll mill or other process. As such, applying force (e.g., a calendaring process) may be repeated to obtain the desired thickness of the free-standing film.

As used herein, the term “dry electrode” should be understood to mean an electrode manufactured by a dry process, rather than not containing any liquid material. Specifically, a dry electrode may be understood as one in which the mixing process using a dispersion solvent is absent during fabrication, and the components of the electrode are dispersed solely through simple mechanical mixing.

In one embodiment, the dry electrode may include 0.1 wt % to 5 wt % of the reduced graphene oxide and 0.1 wt % to 5 wt % of the carbon nanotubes. In some embodiments, the dry electrode may include 0.1 wt % to 5 wt % of the binder. The remaining amount of the dry electrode may be electrode active material.

In embodiments, a dry electrode for a lithium secondary battery may be provided, which includes the conductive material including reduced graphene oxide (rGO) and carbon nanotubes, the electrode active material, and the binder; and in which the conductive material, the electrode active material, and the binder are mixed in a dry manner.

In further embodiments, the method for attaching the dry electrode to an electrode current collector is not particularly limited and may be performed by methods known in the art or as otherwise described herein. For example, in some embodiments, the dry electrode and the electrode current collector may be stacked and then attached to each other by roll pressing at a certain temperature (for example, 70° C. to 80° C.).

In some embodiments, the electrode current collector may be a cathode current collector or an anode current collector, depending on whether the adjacent dry electrode includes a cathode active material or an anode active material.

In embodiments, the cathode current collector may be an electrically conductive plate-shaped substrate. In some further embodiments, the cathode current collector may be provided in the form of a sheet, foil, or thin film. In accordance with the disclosure, the cathode current collector may include at least one of indium (In), copper (Cu), magnesium (Mg), aluminum (Al), stainless steel, iron, and/or combinations thereof. In some embodiments, the cathode current collector may include aluminum such as, for example, aluminum foil.

The thickness of the cathode current collector is not particularly limited and can vary within a typical range such as, for example, 1 μm to 500 μm.

In embodiments, the anode current collector may be an electrically conductive plate-shaped substrate. In some further embodiments, the anode current collector may be provided in the form of a sheet, thin film, or foil. In embodiments, the anode current collector may include a material that does not react with lithium. In some further embodiments, the anode current collector may include at least one of Ni, Cu, SUS (stainless steel), and/or combinations thereof.

The thickness of the anode current collector is not particularly limited and can vary within a typical range such as, for example, 1 μm to 500 μm.

The dry electrode manufactured in accordance with the aspects and embodiments of the various methods described herein can be characterized in that the electrode is manufactured without using a solvent.

In an aspect, the present disclosure provides a secondary battery including the dry electrode in accordance with the aspects and embodiments described herein. The secondary battery includes a cathode current collector, a cathode, a separator, an electrolyte impregnated in the separator, an anode, and an anode current collector, wherein and the cathode current collector, cathode, anode, and anode current collector are in accordance with the aspects and embodiments described above.

In embodiments, the separator serves to separate the anode and the cathode from each other and provides a passage through which lithium ions can move. Any separator commonly used in lithium secondary batteries can be used in accordance with these embodiments. In some further embodiments the separator has low resistance to movement of ions through the electrolyte and/or excellent electrolyte wetting ability. In some further embodiments, the separator can comprise a porous polymer film, for example, a porous polymer film made of a polyolefin polymer such as, for example, an ethylene homopolymer, a propylene homopolymer, an ethylene/butene copolymer, an ethylene/hexene copolymer, an ethylene/methacrylate copolymer, and the like, or a stacked structure of two or more layers thereof. In some embodiments, the separator can comprise a typical porous nonwoven fabric, such as nonwoven fabric made of high-melting-point glass fiber, polyethylene terephthalate fiber, and the like. In some embodiments, the separator can comprise a coated separator containing a ceramic component or a polymer material. In such embodiments, the coated separator may provide heat resistance or mechanical strength, and may optionally be used in a monolayer or multilayer structure.

In embodiments, the electrolyte used in the present disclosure may include, but is not limited to, an organic liquid electrolyte, an inorganic liquid electrolyte, a solid polymer electrolyte, a gel-type polymer electrolyte, a solid inorganic electrolyte, a molten inorganic electrolyte, and the like, any of which may be useful in the manufacture of a lithium secondary battery.

In some further embodiments, the electrolyte may include an organic solvent and a lithium salt.

In embodiments, any organic solvent may be used as long as it acts as a medium through which ions involved in electrochemical reaction of the battery may move. Some non-limiting examples of the organic solvent may include ester solvents such as methyl acetate, ethyl acetate, γ-butyrolactone, ε-caprolactone, and the like; ether solvents such as dibutyl ether or tetrahydrofuran; ketone solvents such as cyclohexanone, and the like; aromatic hydrocarbon solvents such as benzene, fluorobenzene, and the like; carbonate solvents such as dimethylcarbonate (DMC), diethylcarbonate (DEC), methylethylcarbonate (MEC), ethylmethylcarbonate (EMC), ethylene carbonate (EC), propylene carbonate (PC), and the like; alcohol solvents such as ethyl alcohol, isopropyl alcohol, and the like; nitriles such as R—CN (in which R is a linear, branched, or cyclic hydrocarbon group having 2 to 20 carbon atoms and may include a double-bonded aromatic ring or an ether bond), and the like; amides such as dimethylformamide, and the like; dioxolanes such as 1,3-dioxolane, and the like; and sulfolanes. In some embodiments, the organic solvent comprises, a carbonate solvent, and in some further embodiments may comprise a mixture of a cyclic carbonate (e.g., ethylene carbonate or propylene carbonate) having high ionic conductivity and high dielectric constant capable of improving charge/discharge performance of the battery, and a low-viscosity linear carbonate compound (e.g., ethylmethylcarbonate, dimethylcarbonate, or diethylcarbonate). In embodiments comprising such a mixture, the use of the mixture including a cyclic carbonate and the chain (linear) carbonate in a volume ratio of about 1:1 to about 1:9 may result in superior performance of the electrolyte.

Any lithium salt comprising a compound capable of providing lithium ions can be used in a lithium secondary battery in accordance with the disclosure. Some non-limiting examples of the lithium salt may include LiPF₆, LiClO₄, LiAsF₆, LiBF₄, LiSbF₆, LiAlo₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, and LiB(C₂O₄)₂. In embodiments, the concentration of the lithium salt is in the range of 0.1 to 2.0 M, which typically provides electrolyte having appropriate conductivity and viscosity, exhibiting excellent electrolyte performance, and enabling effective movement of lithium ions.

A better understanding of the present disclosure may be obtained through the following illustrative examples and comparative examples. However, these examples are not to be construed as limiting the technical spirit of the present disclosure.

### Preparation Example 1-rGO-1

138 ml of sulfuric acid, 18 g of potassium permanganate, and 3 g of graphite were placed in a reactor and oxidized at 35° C. for 2 hours. The oxidation reaction was terminated by adding a mixed solution of 276 ml of distilled water cooled to 0° C. and 30 ml of 30% hydrogen peroxide solution, synthesizing graphene oxide.

Subsequently, the synthesized graphene oxide was placed in a furnace, heated to 1,100° C., and then pyrolyzed for 1 hour in a reducing atmosphere of nitrogen and hydrogen in a ratio of 90:10, yielding reduced graphene oxide (rGO-1) according to this Preparation Example 1.

### Preparation Example 2-rGO-2

Reduced graphene oxide (rGO-2) according to Preparation Example 2 was prepared in the same manner as in Preparation Example 1, with the exception that, after the oxidation reaction was performed at 35° C. for 2 hours, distilled water was placed in the reactor with the hydrogen peroxide, followed by additional reaction in which the mixture in the reactor was heated to 70° C. and stirred for about 2 hours, synthesizing graphene oxide.

### Preparation Example 3-rGO-3

Reduced graphene oxide (rGO-3) according to Preparation Example 3 was prepared in the same manner as in Preparation Example 1, with the exception that after the oxidation reaction was performed at 35° C. for 2 hours, distilled water was placed in the reactor with the hydrogen peroxide, followed by additional reaction in which the mixture in the reactor was heated to 98° C. and stirred for about 15 minutes, synthesizing graphene oxide.

### Test Example 1

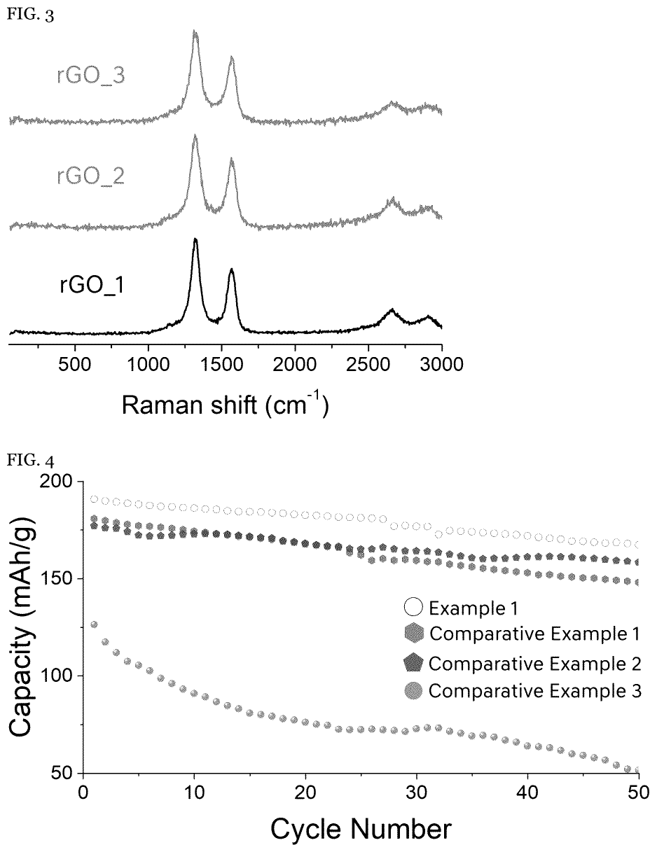

In order to investigate the characteristics of the synthesized reduced graphene oxide, the water contact angles of rGOs according to Preparation Examples 1 to 3 were measured, and the results are shown in FIG. 2. Also, the elements of the synthesized rGOs were analyzed using XPS (X-ray photoelectron spectroscopy), and the results are shown in Table 1 below. In addition, the defects in the crystal structures of the synthesized rGOs were analyzed using Raman spectroscopy, and the results are shown in FIG. 3.

Referring to FIG. 2, the contact angle of rGO_1 was observed to be 146°, rGO_2 was observed to be 141°, and rGO_3 was observed to be 139°. That is, the contact angle of rGO according to Preparation Example 3 was the lowest, and the contact angle of rGO according to Preparation Example 1 was the highest. Accordingly, it is predicted that rGO according to Preparation Example 2 has better affinity with the electrode active material than Preparation Example 1 and rGO according to Preparation Example 3 has better affinity with the electrode active material than Preparation Example 2, and also indicating good dispersibility for all the prepared rGO in the electrode.

TABLE 1

| Sample | Carbon (wt %) | Hydrogen (wt %) | Oxygen (wt %) |
|---|---|---|---|
| rGO_1 | 98.2 | 0.5 | 0 |
| rGO_2 | 98.4 | 0.4 | 0 |
| rGO_3 | 98.2 | 0.4 | 0.2 |

Referring to Table 1, the oxygen content of rGO according to each of Preparation Examples 1 and 2 was lower than that of rGO according to Preparation Example 3. In general, electrical conductivity decreases with an increase in the oxygen content of rGO. Therefore, in terms of oxygen content, the electrical conductivity of rGO according to each of Preparation Examples 1 and 2 is determined to be higher than that of Preparation Example 3.

Also, referring to FIG. 3, I_{D}/I_{G} values of rGO_1 was measured to be 1.75±0.09, I_{D}/I_{G} values of rGO_2 was 1.73±0.07, and I_{D}/I_{G} values of rGO_3 was 1.68±0.09. The I_{D}/I_{G} values of rGOs according to Preparation Examples 1 to 3 were similar and within the error range. In general, electrical conductivity decreases with an increase in the number of defects in the crystal structure. Therefore, in terms of defects, the electrical conductivities of rGOs according to each of Preparation Examples 1 to 3 are determined to be similar.

### EXAMPLES

LiNi_{0.8}Co_{0.1}Mn_{0.1}O₂ (NCM811) as a cathode active material, PTFE as a binder, and single-walled carbon nanotubes (SWCNTs), rGOs according to Preparation Examples 1 to 3, and Super-P as conductive materials were prepared for use. The cathode active material, the binder, and the conductive material were mixed to prepare the Example compositions shown in Table 2 below to obtain 10 g of an electrode composition, to which pressure was then applied, manufacturing a cathode. 10

TABLE 2

| | Active material | Conductive material | | Binder |
|---|---|---|---|---|
| | (weight | | Weight | (weight |
| Classification | ratio) | Type | ratio | ratio) |
| Example 1 | 96 | SWCNT/rGO-1 | 1:1 | 2 |
| Example 2 | 96 | SWCNT/rGO-1 | 1.5:0.5 | 2 |
| Example 3 | 96 | SWCNT/rGO-1 | 0.5:1.5 | 2 |
| Example 4 | 97 | SWCNT/rGO-1 | 0.5:0.5 | 2 |
| Example 5 | 96 | SWCNT/rGO-2 | 1:1 | 2 |
| Example 6 | 96 | SWCNT/rGO-3 | 1:1 | 2 |
| Comparative | 96 | Super-P | 2 | 2 |
| Example 1 | | | | |
| Comparative | 96 | SWCNT | 2 | 2 |
| Example 2 | | | | |
| Comparative | 96 | rGO-1 | 2 | 2 |
| Example 3 | | | | |

### Test Example 2—Example 1 and Comparative Examples 1 to 3

In order to verify performance of the electrode manufactured by the manufacturing method according to the present disclosure, a unit cell was manufactured using the electrode according to the identified Examples in Table 2, and lithium half-cell lifespan characteristics thereof were evaluated.

Specifically, a CR2032 coin-type lithium half-cell was assembled using the electrode according to each of Example 1 and Comparative Examples 1 to 3 as a cathode and lithium metal as a counter electrode.

Thereafter, the lifespan characteristics thereof were compared by performing 50 cycles of charging and discharging at a rate of 0.33 C (1 C=200 mAh/g) at 25° C., and the results thereof are shown in Table 3 below and FIG. 4. FIG. 4 is a graph showing the lifespan characteristics of lithium half-cells that include the dry electrodes according to Example 1 and Comparative Examples 1 to 3 are applied.

TABLE 3

| | Discharge capacity (mAh/g) | | Capacity |
|---|---|---|---|
| | | After 50 cycles of | retention |
| Classification | 1^{st} | charging and discharging | (%) |
| Example 1 | 191.0 | 167.5 | 87.7 |
| Comparative Example 1 | 180.8 | 148.1 | 81.9 |
| Comparative Example 2 | 177.1 | 158.4 | 89.4 |
| Comparative Example 3 | 126.5 | 51.6 | 40.8 |

Referring to FIG. 4 and Table 3, the mixture of rGO and SWCNTs in a ratio of 1:1 exhibited superior capacity and lifespan characteristics compared to conductive materials such as Super-P, SWCNTs, and rGO-1 when used alone. In particular, considering that performance of rGO alone is very poor (Comparative Example 3), improved performance of the dry electrode appears to result from excellent electrical conductivity of SWCNTs. In Example 1, even when the amount of expensive SWCNTs used was decreased by half compared to Comparative Example 2, performance was actually improved likely due to the introduction of relatively inexpensive rGO-1.

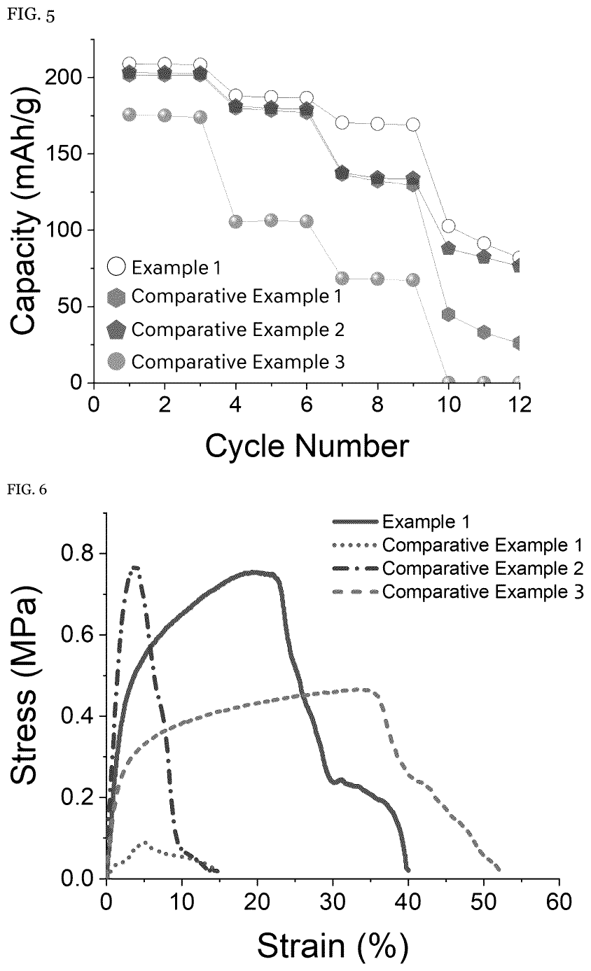

Next, in order to determine the rate characteristics of coin cells manufactured in the same manner as above, charging and discharging were performed while changing the rate. FIG. 5 is a graph showing the rate characteristics of lithium half-cells to which the dry electrodes according to Example 1 and Comparative Examples 1 to 3 are applied, and the results thereof are summarized and shown in Table 4.

TABLE 4

| | Average discharge capacity | | |
|---|---|---|---|
| | (mAh/g) | | 1 C/0.1 C |
| Classification | 0.1 C | 1 C | (%) |
| Example 1 | 208.7 | 91.9 | 44.0 |
| Comparative Example 1 | 201.6 | 34.6 | 17.1 |
| Comparative Example 2 | 203.0 | 82.2 | 40.5 |
| Comparative Example 3 | 174.9 | 0.0 | 0.0 |

Referring to FIG. 5 and Table 4, Example 1, in which the mixture of rGO-1 and SWCNTs in a ratio of 1:1 was used, showed superior rate characteristics in all of 1 C discharge capacity, 0.1 C discharge capacity, and 1 C/0.1 C ratio compared to Comparative Examples 1 to 3, in which conductive materials such as Super-P, SWCNTs, and rGO-1 were used alone without mixing.

Next, in order to confirm the mechanical properties of electrode specimens manufactured depend on the type of conductive material according to Examples and Comparative Examples, tensile strength of the dry electrodes according to Example 1 and Comparative Examples 1 to 3 was measured.

Specifically, tensile strength of the dry electrode specimens according to Example 1 and Comparative Examples 1 to 3 was measured according to ASTM D638 using a universal testing machine (UTM), and the results thereof are shown in FIG. 6 and Table 5 below. FIG. 6 shows the stress-strain curves (as a measure of ductility) of the dry electrodes according to Example 1 and Comparative Examples 1 to 3.

TABLE 5

| Classification | Tensile strength (MPa) |
|---|---|
| Example 1 | 75.3 × 10⁻² |
| Comparative Example 1 | 9.3 × 10⁻² |
| Comparative Example 2 | 76.8 × 10⁻² |
| Comparative Example 3 | 46.6 × 10⁻² |

Referring to FIG. 6 and Table 5, both tensile strength and ductility were very poor in Comparative Example 1 using Super-P as the conductive material. Accordingly, it was confirmed that SWCNTs had the effect of increasing tensile strength of the electrode and rGO had the effect of increasing the ductility of the electrode.

### Test Example 3—Examples 1 to 4 and Comparative Examples 1 and 2

A CR2032 coin-type lithium half-cell was assembled using the electrode according to each of Examples 1 to 4 and Comparative Examples 1 and 2 as a cathode and lithium metal as a counter electrode in the same manner as in Test Example 2, above.

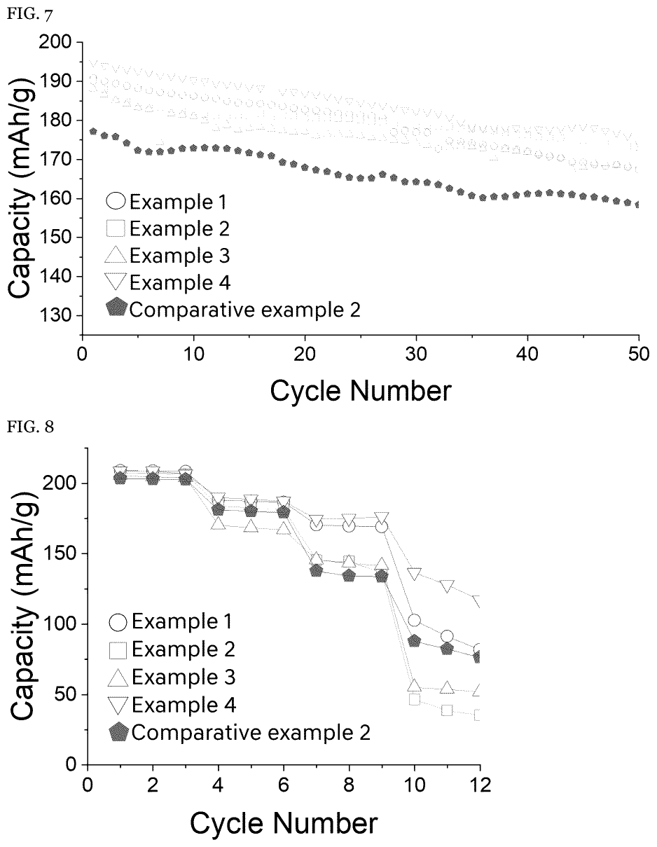

The lifespan characteristics thereof were compared by performing 50 cycles of charging and discharging at a rate of 0.33 C (1 C=200 mAh/g) at 25° C., and the results thereof are shown in Table 6 below and FIG. 7. FIG. 7 is a graph showing the lifespan characteristics of lithium half-cells to which the dry electrodes according to Examples 1 to 4 and Comparative Example 2 are applied.

TABLE 6

| | Discharge capacity (mAh/g) | | Capacity |
|---|---|---|---|
| | | After 50 cycles of | retention |
| Classification | 1^{st} | charging and discharging | (%) |
| Example 1 | 191.0 | 167.5 | 87.7 |
| Example 2 | 190.3 | 173.2 | 91.0 |
| Example 3 | 188.1 | 168.6 | 89.7 |
| Example 4 | 194.8 | 174.3 | 89.4 |
| Comparative Example 2 | 177.1 | 158.4 | 89.4 |

Referring to FIG. 7 and Table 6, when the mixing ratio of SWCNTs and rGO was adjusted, the dry electrode using the mixture of SWCNTs and rGO in all cases showed improved charge/discharge capacity compared to the electrode using SWCNTs alone. In particular, in Example 3, even when the content of SWCNTs was decreased by 75% compared to Comparative Example 2, improved performance was exhibited.

The results indicate that the use of the mixture of SWCNTs and rGO as the conductive material is capable of improving performance while allowing for a decrease in the total amount of SWCNTs.

Next, in order to determine the rate characteristics of coin cells manufactured in the same manner as above, charging and discharging were performed while changing the rate. FIG. 8 is a graph showing the rate characteristics of lithium half-cells to which the dry electrodes according to Examples 1 to 4 and Comparative Example 2 are applied, and the results thereof are summarized and shown in Table 7 below.

TABLE 7

| | Average discharge capacity | | |
|---|---|---|---|
| | (mAh/g) | | 1 C/0.1 C |
| Classification | 0.1 C | 1 C | (%) |
| Example 1 | 208.7 | 91.9 | 44.0 |
| Example 2 | 207.1 | 40.2 | 19.4 |
| Example 3 | 204.8 | 53.6 | 26.2 |
| Example 4 | 208.0 | 127.2 | 61.1 |
| Comparative Example 2 | 203.0 | 82.2 | 40.5 |

Referring to FIG. 8 and Table 7, when the mixing ratio of SWCNTs and rGO was adjusted, the dry electrode using the mixture of SWCNTs and rGO in all cases showed improved lifespan characteristics compared to the electrode using SWCNTs alone. In addition, for the rate characteristics, highest performance was observed when the ratio of rGO and SWCNTs was 1:1. In particular, the rate characteristics were further improved when the total content of rGO and SWCNTs was decreased to 1% (Example 4). This indicates that both the mixing ratio and total content of rGO and SWCNTs are factors that have an effect on the rate characteristics.

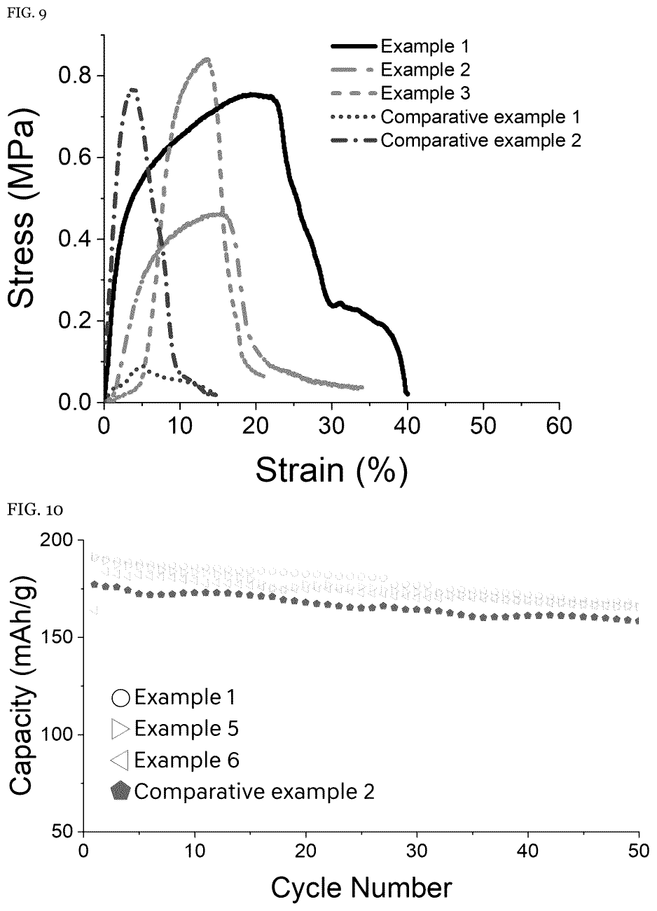

Next, in order to confirm the mechanical properties of the electrode specimens manufactured depend on the type of conductive material according to Examples and Comparative Examples, tensile strength of the dry electrodes according to Examples 1 to 3 and Comparative Examples 1 and 2 was measured in the same manner as in Test Example 2. The results thereof are shown in FIG. 9 and Table 8 below. FIG. 9 shows the stress-strain curves of the dry electrodes according to Examples 1 to 3 and Comparative Examples 1 and 2.

TABLE 8

| Classification | Tensile strength (MPa) |
|---|---|
| Example 1 | 75.3 × 10⁻² |
| Example 2 | 46.0 × 10⁻² |
| Example 3 | 83.4 × 10⁻² |
| Comparative Example 1 | 9.3 × 10⁻² |
| Comparative Example 2 | 76.8 × 10⁻² |

Referring to FIG. 9 and Table 8, both tensile strength and ductility were very poor in Comparative Example 1 using Super-P as the conductive material. On the other hand, Comparative Example 2 using SWCNTs was confirmed to have excellent tensile strength. Accordingly, the data indicates that presence of SWCNTs had the effect of increasing the tensile strength of the electrode and presence of rGO had the effect of increasing the ductility of the electrode.

### Test Example 4—Examples 1, 5, and 6 and Comparative Examples 1 and 2

A CR2032 coin-type lithium half-cell was assembled using the electrode according to each of Examples 1, 5, and 6 and Comparative Examples 1 and 2 as a cathode and lithium metal as a counter electrode in the same manner as in Test Example 2.

The lifespan characteristics thereof were compared by performing 50 cycles of charging and discharging at a rate of 0.33 C (1 C=200 mAh/g) at 25° C., and the results thereof are shown in Table 9 below and FIG. 10. FIG. 10 is a graph showing the lifespan characteristics of lithium half-cells to which the dry electrodes according to Examples 1, 5, and 6 and Comparative Example 2 are applied.

TABLE 9

| | Discharge capacity (mAh/g) | | Capacity |
|---|---|---|---|
| | | After 50 cycles of | retention |
| Classification | 1^{st} | charging and discharging | (%) |
| Example 1 | 191.0 | 167.5 | 87.7 |
| Example 5 | 191.7 | 165.7 | 86.4 |
| Example 6 | 183.9 | 166.1 | 90.3 |
| Comparative Example 2 | 177.1 | 158.4 | 89.4 |

Referring to FIG. 10 and Table 9, for charge/discharge capacity and lifespan characteristics, there was no significant difference between Examples 1, 5, and 6, which incorporate one of rGO-1, rGO-2, or rGO-3, the properties of which were controlled by changing additional reaction conditions, and absolute capacity was somewhat improved compared to Comparative Example 2, in which SWCNTs were used alone as the conductive material.

Next, in order to determine the rate characteristics of coin cells manufactured in the same manner as above, charging and discharging were performed while changing the rate. FIG. 11 is a graph showing the rate characteristics of lithium half-cells using the dry electrodes according to Examples 1, 5, and 6 and Comparative Example 2, and the results thereof are summarized and shown in Table 10 below.

TABLE 10

| | Average discharge capacity | | |
|---|---|---|---|
| | (mAh/g) | | 1 C/0.1 C |
| Classification | 0.1 C | 1 C | (%) |
| Example 1 | 208.7 | 91.9 | 44.0 |
| Example 5 | 209.3 | 130.5 | 62.3 |
| Example 6 | 203.8 | 65.5 | 32.2 |
| Comparative Example 2 | 203.0 | 82.2 | 40.5 |

Referring to FIG. 11 and Table 10, synthesis of rGO under different conditions showed a large difference in rate characteristics. Specifically, rGO-2 showed improved rate characteristics compared to dry electrodes using rGO-1 and rGO-3. This is consistent with the prediction observed in Test Example 1, showing that rGO-2 and rGO-3 had enhanced hydrophilicity compared to rGO-1 and that electrical conductivity would be higher because the content of oxygen functional group in rGO-2 was lower than that in rGO-3. The data appears to indicate improved characteristics, perhaps approaching an optimum, in terms of hydrophilicity and electrical conductivity are achieved, thereby creating conditions allowing for dispersion of the conductive material and improvement in battery performance.

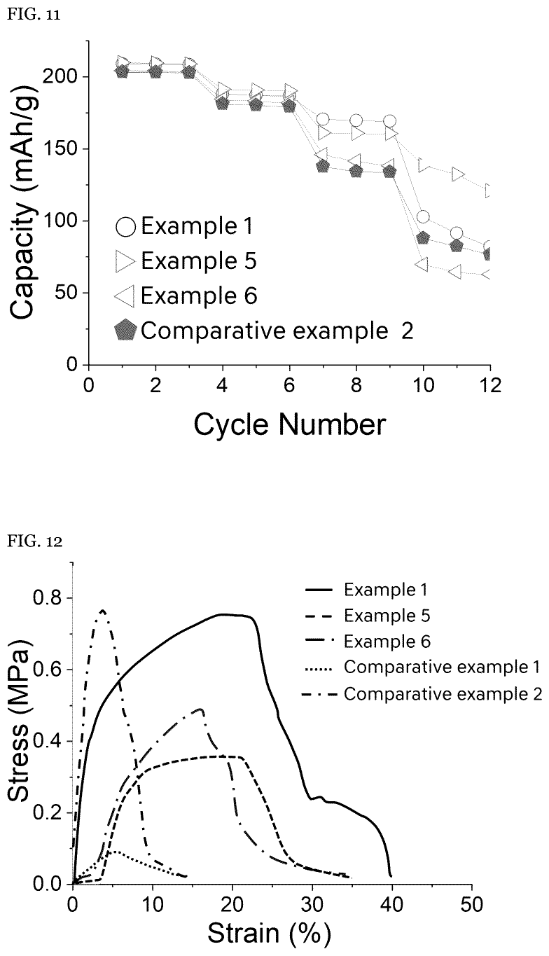

Next, in order to confirm the mechanical properties of the electrode specimens manufactured depending on the type of conductive material according to Examples and Comparative Examples, tensile strength of the dry electrodes according to Examples 1, 5, and 6 and Comparative Examples 1 and 2 was measured in the same manner as in Test Example 2. The results thereof are shown in FIG. 12 and Table 11 below. FIG. 12 shows the stress-strain curves of the dry electrodes according to Examples 1, 5, and 6 and Comparative Examples 1 and 2.

TABLE 11

| Classification | Tensile strength (MPa) |
|---|---|
| Example 1 | 75.3 × 10⁻² |
| Example 5 | 35.7 × 10⁻² |
| Example 6 | 48.4 × 10⁻² |
| Comparative Example 1 | 9.3 × 10⁻² |
| Comparative Example 2 | 76.8 × 10⁻² |

Referring to FIG. 12 and Table 11, the tensile strength showed an increase or decrease depending on the type of rGO, but are still vastly superior compared to the conventional Super-P-based dry electrode.

### Test Example 5

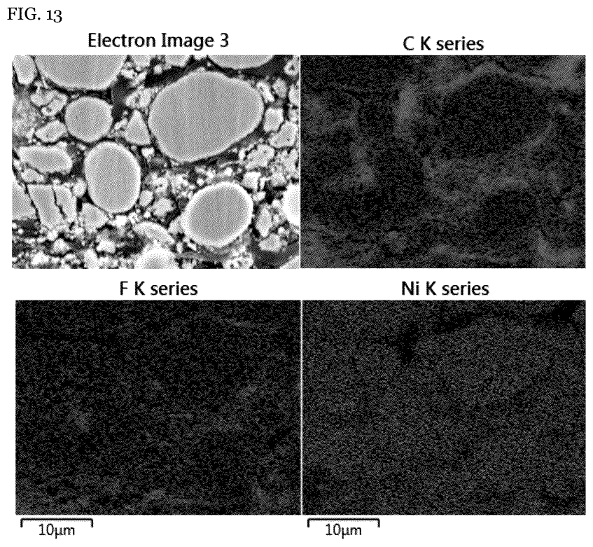

In order to confirm the distribution of the conductive material in the dry electrode, the dry electrode according to Example 5 was analyzed using energy dispersive X-ray spectroscopy, and the results are shown in FIG. 13.

Referring to FIG. 13, it was confirmed for the dry electrode according to Example 5 that the conductive material was uniformly distributed over the entire surface of the active material. When SWCNTs, a one-dimensional carbon material, are used alone as the conductive material, agglomeration may occur, making dispersion thereof in the electrode difficult. However, in the present disclosure, an agglomeration phenomenon was minimized by rGO, confirming that the conductive material was uniformly distributed on the surface of the active material.

Here, Ni—K may refer to the Ni element contained in the cathode active material, C—K may indicate the C element present in the conductive material, and F—K may represent the F element contained in the binder.

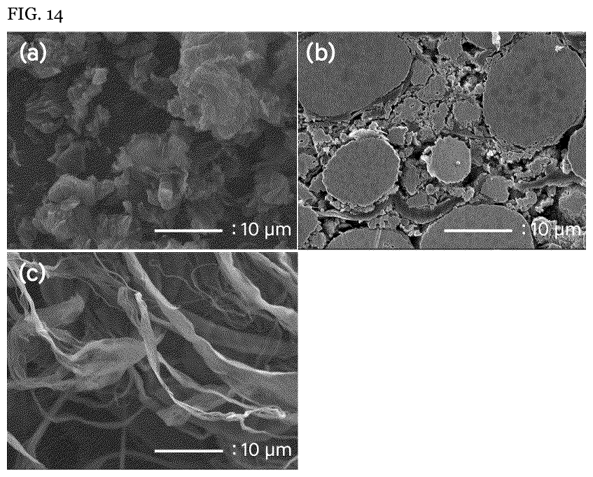

In addition, the cross-section of the dry electrode according to Example 5 was analyzed using scanning electron microscopy-energy dispersive X-ray spectroscopy (SEM-EDS), and which are shown in FIG. 14(b). For reference, FIG. 14(a) and FIG. 14(c) show results of SEM-EDS of respective shapes of rGO-2 and SWCNTs to more easily analyze the cross-section of the dry electrode according to Example 5.

Referring to FIG. 14(b), the fiberized PTFE binder and the SWCNTs were observed throughout the cross-section of the dry electrode according to Example 5, but a shape similar to rGO was not observed. This shows superior dispersibility of rGO compared to SWCNTs, which indicates that rGO is uniformly distributed in the electrode without agglomeration. This uniform distribution may alleviate agglomeration between SWCNTs and promote additional electrical conduction pathways.

As is apparent from the foregoing data, the disclosure provides a method of manufacturing a dry electrode for a lithium secondary battery that includes obtaining an electrode composition by mixing a conductive material, an electrode active material, and a binder in a dry manner without using a separate dispersion medium and then manufacturing an electrode for a lithium secondary battery by applying pressure to the electrode composition. This method avoids process steps for removing a dispersion medium and can prevent damage to an electrode active material due to any high-temperature drying process.

In addition, a mixture of carbon nanotubes, a one-dimensional carbon material, and reduced graphene oxide (rGO), a two-dimensional carbon material, is used as the conductive material included in the electrode, making it possible to manufacture an electrode for a lithium secondary battery in which dispersion of the conductive material in the electrode is improved, easy to achieve, and can provide a sufficient specific surface area.

Furthermore, when synthesizing graphene oxide by placing water in a reactor followed by additional reaction, hydrophilicity and electrical conductivity of reduced graphene oxide can be improved by controlling additional reaction conditions.

The effects and advantages associated with the present disclosure are not limited to the foregoing. It should be understood that the effects and advantages of the present disclosure include all effects and advantages that can be derived or inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A method of manufacturing a dry electrode for a lithium secondary battery, comprising:
preparing a conductive material comprising reduced graphene oxide (rGO) and carbon nanotubes;
obtaining an electrode composition by mixing the conductive material with an electrode active material and a binder; and
manufacturing the dry electrode by applying pressure to the electrode composition.

2. The method of claim 1, wherein preparing the conductive material comprises:
reacting an acid solution, graphite, and an oxidizing agent in a reactor;
synthesizing graphene oxide by proceeding with additional reaction through adding water in the reactor; and
synthesizing reduced graphene oxide by pyrolyzing the graphene oxide under a reducing atmosphere.

3. The method of claim 2, wherein the additional reaction is performed under any one of conditions of:
0° C. to 10° C. for less than 1 minute;
65° C. to 75° C. for 90 to 150 minutes; and/or
98° C. to 100° C. for 10 to 20 minutes.

4. The method of claim 1, wherein a weight ratio of the reduced graphene oxide to the carbon nanotubes is 0.5:1.5 to 1.5:0.5.

5. The method of claim 1, wherein the dry electrode comprises 0.1 wt % to 5 wt % of the reduced graphene oxide, 0.1 wt % to 5 wt % of the carbon nanotubes, and 0.1 wt % to 5 wt % of the binder.

6. The method of claim 1, wherein an oxygen content in the reduced graphene oxide is 0.2 wt % or less.

7. The method of claim 1, wherein the carbon nanotubes comprise an average length of 0.1 μm to 200 μm, an average diameter of 1 nm to 20 nm, and an oxygen content of 0 wt % to 10 wt %.

8. The method of claim 1, further comprising attaching the dry electrode to an electrode current collector.

9. A dry electrode for a lithium secondary battery, comprising:
a conductive material comprising reduced graphene oxide (rGO) and carbon nanotubes;
an electrode active material; and
a binder,
wherein the conductive material, the electrode active material, and the binder are mixed in a dry manner.

10. The dry electrode of claim 9, comprising a weight ratio of the reduced graphene oxide to the carbon nanotubes ranging from 0.5:1.5 to 1.5:0.5.

11. The dry electrode of claim 9, wherein the dry electrode comprises 0.1 wt % to 5 wt % of the reduced graphene oxide, 0.1 wt % to 5 wt % of the carbon nanotubes, and 0.1 wt % to 5 wt % of the binder.

12. The dry electrode of claim 9, wherein an oxygen content in the reduced graphene oxide is 0.2 wt % or less.

13. The dry electrode of claim 9, wherein the carbon nanotubes comprise an average length of 0.1 μm to 200 μm, an average diameter of 1 nm to 20 nm, and an oxygen content of 0 wt % to 10 wt %.

14. A lithium secondary battery comprising the dry electrode of claim 9.

15. A lithium secondary battery comprising the dry electrode prepared according to the method of claim 1.
